(19) United States
(12) Patent Application Publication
(10) Pub. No.: US 2025/0277504 A1
(43) Pub. Date: Sep. 4, 2025

(54) FIXING STRUCTURE FOR PIPE NUT

(71) Applicant: SUBARU CORPORATION, Tokyo (JP)

(72) Inventors: Kyosuke HIRAZUMI, Tokyo (JP); Ryo KOJIMA, Tokyo (JP)

(73) Assignee: SUBARU CORPORATION, Tokyo (JP)

(21) Appl. No.: 19/019,698

(22) Filed: Jan. 14, 2025

(30) Foreign Application Priority Data
Mar. 4, 2024 (JP) 2024-032376

(51) Int. Cl. F16B 39/12; F16B 37/00

(52) U.S. Cl. CPC F16B 39/12; F16B 37/00

(57) ABSTRACT

A fixing structure for a pipe nut includes a pipe nut main body, a first stopper, and a second stopper. A female screw portion is provided inside of the pipe nut main body, and the pipe nut main body penetrates a vehicle body frame having a hollow cross section. The first stopper is provided at a base end of the pipe nut main body and abuts on an outer surface of the vehicle body frame to restrict movement of the pipe nut main body in a longitudinal direction. The second stopper is provided on the pipe nut main body and abuts on a surface of the vehicle body frame different from the outer surface of the vehicle body frame on which the first stopper abuts, and the second stopper restricts movement of the pipe nut main body in the longitudinal direction.

### CROSS-REFERENCE TO RELATED APPLICATION

The present application claims priority from Japanese Patent Application No. 2024-032376 filed on Mar. 4, 2024, the entire contents of which are hereby incorporated by reference.

### BACKGROUND

The disclosure relates to a fixing structure for a pipe nut provided on a vehicle body frame for fastening a sub frame to the vehicle body frame by a bolt.

Conventionally, front side frames extending in a front-rear direction are disposed as vehicle body frames on both sides of a front portion of a vehicle body of an automobile or the like, for example. On lower portions of the front side frames, for example, a suspension cross member that supports suspensions and the like is extended in the vehicle width direction as a sub frame.

Both ends of such a suspension cross member are generally attached to each of the front side frames by bolt fastening. Therefore, in order to fasten both ends of the suspension cross member to each of the front side frames by bolts, the front side frames are provided with pipe nuts each having a female screw portion therein.

The pipe nuts are generally joined to the front side frame by a welding means such as spot welding or arc welding.

Conventionally, various techniques have been proposed as a fixing structure for a pipe nut for enhancing attachment rigidity.

For example, in Japanese Patent No. 6337342, a pipe nut protrudes upward in a state of being inserted from below a vehicle body frame. Further, a flange of a proximal end of the pipe nut is brought into contact with a bottom surface of the vehicle body frame. Then, a fixing structure for the pipe nut is disclosed in which an outer periphery of a flange abutting on the bottom surface of the vehicle body frame is joined by arc welding.

Incidentally, the flange is provided with a bearing surface for abutting an attachment portion of the suspension cross member. In the arc welding for joining the outer periphery of the flange provided with such a bearing surface, spatter occurs during welding. Therefore, during arc welding, it is necessary to protect the bearing surface with a masking material to prevent spatter from adhering. In order to protect the bearing surface with the masking material, a process of attaching and detaching the masking material before and after the arc welding process is separately performed. In the technique disclosed in Japanese Patent No. 6337342, a step of attaching and detaching a masking material is separately performed, and accordingly, there is inconvenience that work man-hours are increased and production efficiency is lowered.

As a welding means for preventing such a decrease in production efficiency and increasing the production efficiency, for example, welding by spot welding in which spatter hardly occurs is also conceivable.

### SUMMARY

An aspect of the disclosure provides a fixing structure for a pipe nut. The fixing structure for a pipe nut includes a pipe nut main body, a first stopper, and a second stopper. A female screw portion is provided inside of the pipe nut main body, and the pipe nut main body penetrates a vehicle body frame having a hollow cross section. The first stopper is provided at a base end of the pipe nut main body and abuts on an outer surface of the vehicle body frame to restrict movement of the pipe nut main body in a longitudinal direction. The second stopper is provided on the pipe nut main body and abuts on a surface of the vehicle body frame different from the outer surface of the vehicle body frame on which the first stopper abuts, and the second stopper restricts movement of the pipe nut main body in the longitudinal direction.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is an exploded perspective view of a vehicle body frame and a suspension cross member according to an embodiment;

FIG. 2 is an enlarged perspective view of a main part of the vehicle body frame according to the embodiment;

FIG. 3 is an enlarged exploded perspective view of the main part of the vehicle body frame according to the embodiment;

FIG. 4 is a cross-sectional view taken along line IV-IV of FIG. 2 according to the embodiment;

FIG. 5 is a perspective view of a pipe nut according to the embodiment from an obliquely lower side;

FIG. 6 is a cross-sectional view taken along line VI-VI of FIG. 4 according to the embodiment;

FIG. 7 is a cross-sectional view corresponding to FIG. 6 according to an embodiment; and

FIG. 8 is a cross-sectional view corresponding to FIG. 6 according to an embodiment.

### DETAILED DESCRIPTION

In spot welding, it may be difficult to ensure attachment rigidity of a pipe nut as compared with arc welding in which joining is performed by a line.

It is desirable to provide a fixing structure for a pipe nut capable of enhancing production efficiency and ensuring attachment rigidity of the pipe nut to a vehicle body frame even when the pipe nut is joined to the vehicle body frame by spot welding.

Hereinafter, embodiments of the disclosure will be described with reference to the drawings.

Note that, in the drawings used in the following description, scales are different for each component in order to make each component recognizable in the drawings. Therefore, the disclosure is not limited only to the illustrated form with respect to the quantities of components, the shapes of components, the ratios of the sizes of components, the relative positional relationship of components, and the like described in these drawings. Further, in the following description, in a case where “joining” is described, the joining method is performed using a joining means represented by fusion welding, mechanical joining, or the like. Note that, in the drawing, a spot welding symbol is attached to a spot welding point indicating a characteristic portion, and display of the welding symbol is omitted at other welding points.

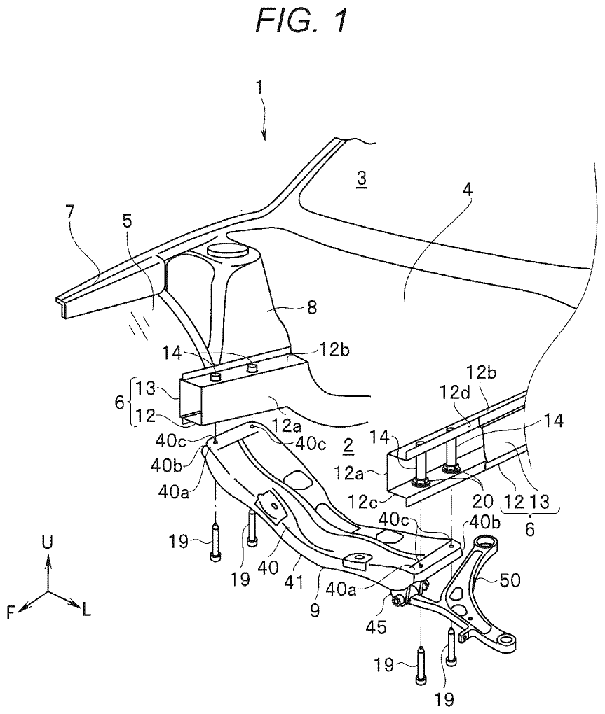

As illustrated in FIG. 1, an engine room 2 is provided in a front portion of the vehicle body 1.

The engine room 2 is partitioned from the rear cabin 3 by a toe board 4.

As frames constituting such an engine room 2, the vehicle body 1 includes a pair of left and right front side frames 6, a pair of left and right upper side frames 7, and a suspension cross member 9. These frames are formed by, for example, pressing a sheet metal member made of a high-strength steel plate or the like.

Note that the basic structure around the pair of left and right front side frames 6 and the pair of left and right upper side frames 7 is bilaterally symmetrical. Therefore, the left side of the vehicle body will be described below as an example.

As illustrated in FIG. 1, the front side frames 6 extend from a lower portion of the toe board 4 toward the front of the vehicle body 1 on outsides of the toe board 4 in a vehicle width direction.

The upper side frames 7 are provided above the front side frames 6 and outside the front side frames 6 in the vehicle width direction. The upper side frames 7 extend forward of the vehicle body along the engine room 2.

A suspension tower 8 is provided between each of the front side frames 6 and each of the upper side frames 7 near the rear of the engine room 2.

The suspension tower 8 houses a suspension device (not illustrated) therein. The suspension tower 8 supports an upper portion of the suspension device.

Furthermore, a wheel apron 5 is provided between each of the front side frames 6 and each of the upper side frames 7 in front of the suspension tower 8.

The suspension cross member 9 is disposed as a sub frame on lower portions of the front side frames 6. That is, the suspension cross member 9 extends in the vehicle width direction at the lower portions of the front side frames 6. The suspension cross member 9 has a shape in which a central portion is curved downward.

Ends of the suspension cross member 9 in the vehicle width direction are joined to bottom surfaces of the front side frames 6 by bolt fastening.

In order to fasten such a suspension cross member 9 by bolts, the front side frames 6 as a vehicle body frame are each provided with a pair of front and rear pipe nuts 14.

The configurations of the front side frames 6 and the suspension cross member 9 will be described in detail below.

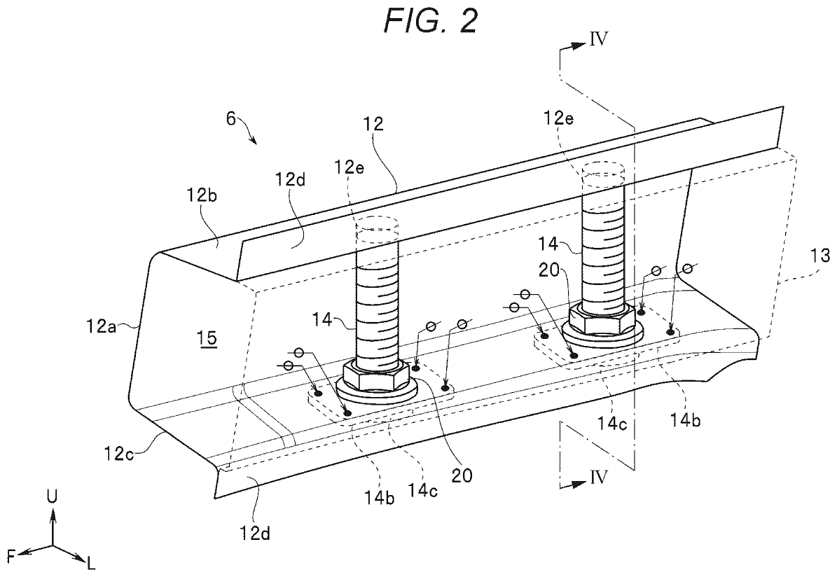

As illustrated in FIGS. 1 and 2, the front side frames 6 each include an inner frame 12 and an outer frame 13. Note that, in FIG. 1, a part of the outer frame 13 of the left front side frame 6 is omitted.

As illustrated in FIGS. 2 to 4, the inner frame 12 has a substantially hat-shaped cross section protruding inward in the vehicle width direction. Such an inner frame 12 includes an inner wall 12a, an upper wall 12b, a lower wall 12c, and a pair of upper and lower inner flanges 12d.

The inner wall 12a extends in the vehicle body vertical direction.

The upper wall 12b and the lower wall 12c extend outward in the vehicle width direction from both ends of the inner wall 12a.

The pair of upper and lower inner flanges 12d extends in the vehicle body vertical direction from outer edges of the upper wall 12b and the lower wall 12c in the vehicle width direction. Each of the inner flanges 12d functions as a flange for joining the inner frame 12 to the outer frame 13.

As illustrated in FIGS. 2 to 4, the outer frame 13 has a substantially hat-shaped cross section with a depth shallower than that of the inner frame 12. The outer frame 13 is disposed at a position facing the outside of the inner frame 12 in the vehicle width direction. For example, the opening of the outer frame 13 faces the opening of the inner frame 12.

The outer frame 13 disposed in this manner has an outer wall 13a at a position facing the inner wall 12a of the inner frame 12. The outer frame 13 further includes a pair of upper and lower outer flanges 13b at respective positions facing the inner flanges 12d.

Such an outer frame 13 is joined in a state where the outer flanges 13b are brought into contact with the inner flanges 12d.

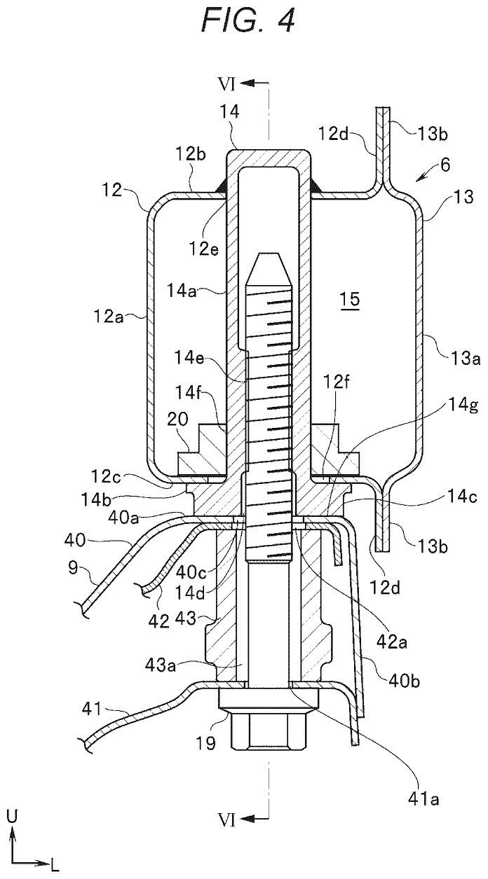

Thus, as illustrated in FIG. 4, the front side frame 6 has a substantially rectangular cross section having a hollow cross section 15.

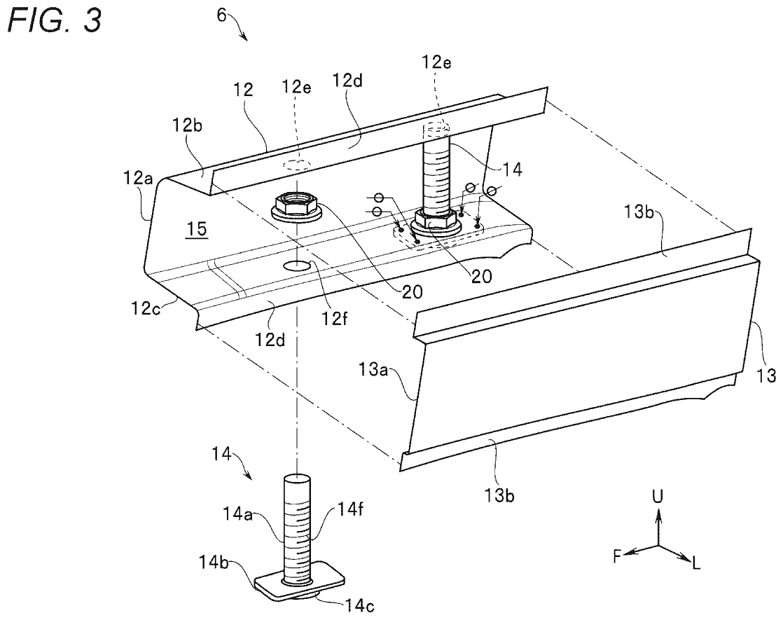

With respect to the front side frame 6, the pair of front and rear pipe nuts 14 is provided in a state of penetrating the front side frame 6 in the vertical direction of the vehicle body 1. Thus, as illustrated in FIGS. 3 and 4, a pair of front and rear upper insertion holes 12e and a pair of front and rear lower insertion holes 12f are provided in each of the upper wall 12b and the lower wall 12c of the front side frame 6.

The pair of front and rear upper insertion holes 12e and the pair of front and rear lower insertion holes 12f are disposed at positions facing each other. That is, the insertion holes 12e and 12f are arranged substantially coaxially. The diameter of each of the insertion holes 12e and 12f is set slightly larger than the outer diameter of the pipe nut 14.

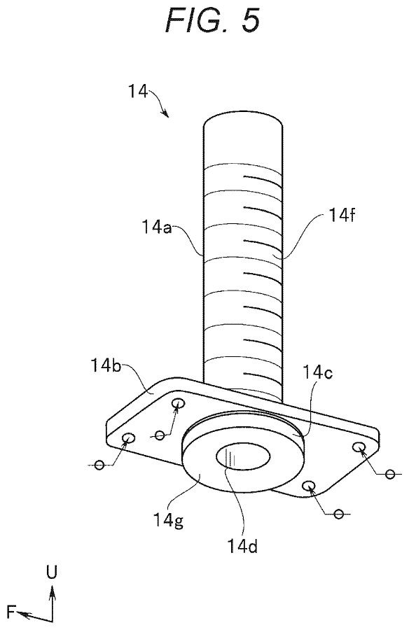

The pipe nut 14 is inserted into each of the insertion holes 12e and 12f from below. As illustrated in FIG. 5, the pipe nut 14 includes a pipe nut main body 14a, a joining flange 14b, and a boss portion 14c.

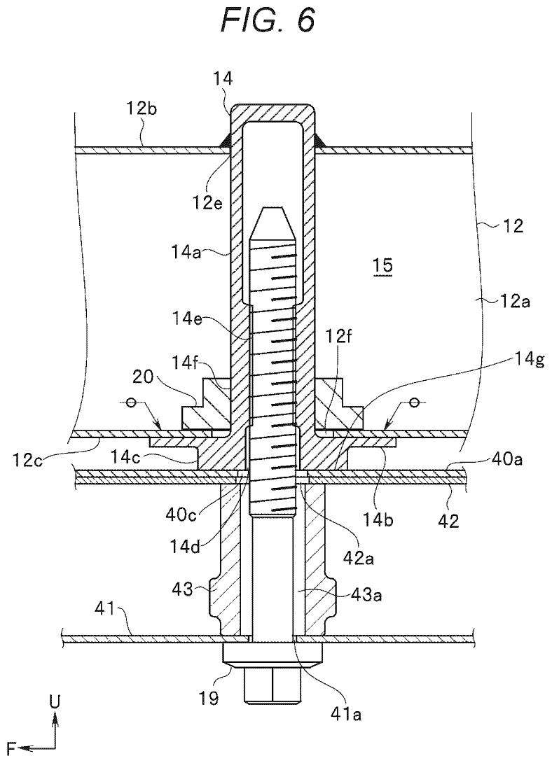

As illustrated in FIGS. 4 and 6, the pipe nut main body 14a has, for example, a substantially cylindrical shape with one end closed. The hole formed in the pipe nut main body 14a is set as a bolt insertion hole 14d. Furthermore, a female screw portion 14e is formed on an inner peripheral surface of the bolt insertion hole 14d. Note that a bolt 19 to be described later can be screwed into the female screw portion 14e.

A male screw portion 14f is formed on an outer peripheral surface of the pipe nut main body 14a. The male screw portion 14f is formed, for example, from a middle position close to a distal end (upper end) in a longitudinal direction of the pipe nut main body 14a to a base end.

The joining flange 14b is formed at the base end of the pipe nut main body 14a. As illustrated in FIGS. 2 to 6, the joining flange 14b extends in the front-rear direction of the vehicle body along an outer surface of the lower wall 12c of the inner frame 12. That is, the shape of the joining flange 14b is a rectangle that is long in the vehicle body front-rear direction along the lower wall 12c.

Such a joining flange 14b functions as a first stopper that restricts the movement of the pipe nut main body 14a in the longitudinal direction when abutting on the outer surface of the lower wall 12c.

Further, a portion of the joining flange 14b extending in the front-rear direction of the vehicle body functions as a welded portion with the lower wall 12c. That is, the joining flange 14b allows spot-welding of four corners of the joining flange 14b in a state of being in contact with the outer surface of the lower wall 12c. By this spot welding, the joining flange 14b can be joined to the plate surface of the lower wall 12c.

Here, the length of the joining flange 14b in the front-rear direction of the vehicle body is preferably set to be longer than at least the length of the lower wall 12c in the vehicle width direction. With such a configuration, when the pipe nut 14 rotates about an axis, the joining flange 14b can be brought into contact with the inner flange 12d. Thus, the joining flange 14b restricts rotation of the pipe nut 14 as a whirl-stop.

As illustrated in FIG. 5, the boss portion 14c is formed to protrude downward from the joining flange 14b. The boss portion 14c is formed in an annular shape. The protruding surface of the boss portion 14c is provided with a bearing surface 14g.

As illustrated in FIGS. 4 and 6, an upper surface of the suspension cross member 9 abuts on the bearing surface 14g. That is, the bearing surface 14g functions as an attachment surface when the suspension cross member 9 is fasten by bolts. Therefore, the bearing surface 14g is substantially flat.

Inside the front side frame 6, the nut 20 is screwed onto the male screw portion 14f of the pipe nut 14 when being inserted into the lower insertion hole 12f. Note that the nut 20 is screwed before the outer frame 13 is joined to the inner frame 12.

By such screwing onto the male screw portion 14f, the nut 20 is disposed at a position in contact with an inner surface of the lower wall 12c. Thus, the nut 20 functions as a second stopper that restricts the movement of the pipe nut main body 14a in the longitudinal direction.

Then, the nut 20 sandwiches the plate member of the lower wall 12c with the joining flange 14b. In this manner, the nut 20 can firmly fix the pipe nut 14 to the lower wall 12c of the front side frame 6.

Note that the diameter of the nut 20 is set to be larger than the diameter of the lower insertion hole 12f in order to accurately sandwich the lower wall 12c. In order to achieve such a diameter of the nut 20, it is preferable to use a flange nut as the nut 20.

By the fixing using the joining flange 14b and the nut 20, a state in which the pipe nut main body 14a penetrates the lower insertion hole 12f of the lower wall 12c and also penetrates the upper insertion hole 12e of the upper wall 12b is maintained.

As illustrated in FIG. 6, the joining flange 14b of the pipe nut 14 fixed in this manner is joined to the lower wall 12c by spot welding. Further, a distal end side of the pipe nut main body 14a is joined to an outer surface of the upper wall 12b by arc welding in a state of being inserted into the upper insertion hole 12e.

As illustrated in FIGS. 1, 4, and 6, the suspension cross member 9 includes an upper panel 40, a lower panel 41, and a reinforcement 42.

The upper panel 40 has, for example, an open cross-sectional shape whose cross section is open toward the lower side of the vehicle body. As illustrated in FIG. 4, such an upper panel 40 includes an attachment portion 40a and a side wall 40b.

The attachment portion 40a is disposed at a position facing the lower wall 12c. The attachment portion 40a abuts on the bearing surface 14g of the pipe nut 14 and functions as an attachment portion for fixing the suspension cross member 9 to the front side frame 6.

Thus, the attachment portion 40a has a pair of front and rear first bolt insertion holes 40c.

The pair of front and rear first bolt insertion holes 40c is provided at respective positions facing the bolt insertion holes 14d. That is, the first bolt insertion holes 40c and the bolt insertion holes 14d are arranged substantially coaxially.

The side wall 40b extends downward from an outer edge of the attachment portion 40a in the vehicle width direction.

The lower panel 41 is disposed at a position facing the upper panel 40 with a space therebetween. The lower panel 41 is provided with a second bolt insertion hole 41a at a position facing each of the first bolt insertion holes 40c. That is, the second bolt insertion holes 41a and the first bolt insertion holes 40c are arranged substantially coaxially.

The outer edge of the lower panel 41 in the vehicle width direction is bent downward. In this manner, a lower end of the side wall 40b of the upper panel 40 is joined to an outer surface of the bent lower panel 41 in the vehicle width direction.

By joining the upper panel 40 and the lower panel 41, an internal space is formed in the suspension cross member 9.

The reinforcement 42 is disposed inside the suspension cross member 9. For example, the reinforcement 42 extends in the vehicle width direction along the upper panel 40.

As illustrated in FIG. 4, the outer end of the reinforcement 42 in the vehicle width direction is in contact with the inner surface of the attachment portion 40a. Then, an outer end of the reinforcement 42 in the vehicle width direction is joined to the attachment portion 40a.

Further, the joint portion of the reinforcement 42 is provided with a third bolt insertion hole 42a at a position facing each first bolt insertion hole 40c. That is, each third bolt insertion hole 42a and each of the first and second bolt insertion holes 40c and 41a are arranged substantially coaxially.

As illustrated in FIGS. 4 and 6, a pair of front and rear spacers 43 is extended between the reinforcement 42 and the lower panel 41.

The pair of front and rear spacers 43 has a substantially cylindrical shape. The hole formed in each spacer 43 is set as a fourth bolt insertion hole 43a penetrating in the vehicle body vertical direction. That is, the fourth bolt insertion hole 43a of each spacer 43 is disposed substantially coaxially with each of the first to third bolt insertion holes 40c, 41a, and 42a.

A bolt 19 can be inserted into the first to fourth bolt insertion holes 40c, 41a, 42a, and 43a arranged in this manner.

Note that, in the following description, the first to fourth bolt insertion holes 40c, 41a, 42a, and 43a are collectively referred to as a bolt insertion hole H.

With such a configuration, the suspension cross member 9 is fixed to the front side frame 6 by bolt fastening.

For example, when the suspension cross member 9 is fixed to the front side frame 6, the attachment portion 40a abuts on each of the bearing surfaces 14g from below.

Further, each bolt insertion hole H is positioned with respect to the bolt insertion hole 14d of each of the pipe nuts 14.

The bolt 19 is inserted into the bolt insertion hole H and the bolt insertion hole 14d of each set positioned from below the bolt insertion hole H. Then, each bolt 19 is screwed into the female screw portion 14e of the pipe nut 14. Thus, the suspension cross member 9 is fixed to the front side frame 6 by fastening.

An arm support portion 45 is provided on the outside in the vehicle width direction of the suspension cross member 9 fixed in this manner.

For example, as illustrated in FIG. 1, the arm support portion 45 protrudes downward from a bottom surface on the outside in the vehicle width direction of the lower panel 41. A base end of a suspension lower arm 50 is pivotally supported by the arm support portion 45. Thus, a distal end side of the suspension lower arm 50 is swingable in the vertical direction.

A lower portion of a suspension device, which is not illustrated, is supported outside the suspension lower arm 50 in the vehicle width direction. Furthermore, a wheel hub, which is not illustrated, for fixing the front wheel is rotatably supported on the outside in the vehicle width direction of the suspension lower arm 50.

According to such an embodiment, a fixing structure of the pipe nut 14 includes the pipe nut main body 14a in which the female screw portion 14e is formed inside, and the pipe nut main body penetrating the front side frame 6 having the hollow cross section 15, the joining flange 14b that is provided at the base end of the pipe nut main body 14a and abuts on an outer surface of the front side frame 6 to restrict movement of the pipe nut main body 14a in the longitudinal direction, and the nut 20 that is provided on the pipe nut main body 14a and abuts on a surface of the front side frame 6 different from the outer surface of the front side frame 6 on which the joining flange 14b abuts, the nut 20 restricting movement of the pipe nut main body 14a in the longitudinal direction.

With these configurations, the fixing structure of the pipe nut 14 can enhance production efficiency and ensure attachment rigidity of the pipe nut 14 to the vehicle body frame even when the pipe nut 14 is joined to the vehicle body frame by spot welding.

That is, in the present embodiment, the pipe nut 14 has the pipe nut main body 14a penetrating the front side frame 6. Further, at the base end of the pipe nut main body 14a, the joining flange 14b that abuts on the outer surface of the front side frame 6 to restrict movement in the longitudinal direction is provided. Furthermore, the pipe nut main body 14a is provided with the nut 20 that abuts on a surface of the front side frame 6 different from the surface on which the joining flange 14b abuts and restricts the movement in the longitudinal direction.

With these configurations, the fixing structure of the pipe nut 14 of the present embodiment can firmly fix the pipe nut 14 to the front side frame 6. Thus, the pipe nut 14 can generate a sufficient drag against loads in a prying direction (direction inclined with respect to the central axis) and the longitudinal direction input to the pipe nut main body 14a via the suspension cross member 9 during traveling. Therefore, even when the joining flange 14b is joined to the lower wall 12c by spot welding, sufficient attachment rigidity of the pipe nut 14 with respect to the front side frame 6 can be ensured.

In addition, using spot welding for joining the joining flange 14b to the lower wall 12c can significantly reduce the amount of spatter (melted metal powder) generated as compared with arc welding. Therefore, the amount of spatter adhering to the bearing surface 14g during welding can be significantly reduced. Therefore, in a welding step of the present embodiment in which spot welding can be used, the attaching and detaching step of a masking material for protecting the bearing surface 14g is unnecessary. As a result, the fixing structure of the pipe nut 14 of the present embodiment can enhance the production efficiency.

In addition, the nut 20 sandwiches the plate member of the lower wall 12c of the front side frame 6 with the joining flange 14b inside the front side frame 6. That is, the joining flange 14b and the lower wall 12c are brought into pressure contact with each other by the nut 20. Thus, when the joining flange 14b is spot-welded to the lower wall 12c, welding can be performed in a state where the contact area between the joining flange 14b and the lower wall 12c is enlarged. Therefore, welding accuracy at the time of spot welding can be enhanced.

Further, the distal end of the pipe nut main body 14a protrudes from the upper wall 12b in a state of being inserted into the upper insertion hole 12e of the front side frame 6. That is, the distal end of the pipe nut main body 14a protrudes to a position above and away from the bearing surface 14g. Thus, the amount of spatter generated when the pipe nut main body 14a is welded to the upper wall 12b reaches the bearing surface 14g is limited. Therefore, even when the distal end of the pipe nut main body 14a is firmly joined by arc welding, a masking material for protecting the bearing surface 14g is unnecessary. As a result, in the fixing structure of the pipe nut 14 of the present embodiment, the distal end of the pipe nut 14 can be fixed by arc welding without lowering the production efficiency.

Further, the joining flange 14b has a rectangular shape elongated in the vehicle body front-rear direction along the lower wall 12c. Thus, when the joining flange 14b abuts on the outer surface of the lower wall 12c, it is possible to accurately restrict the movement of the pipe nut main body 14a in the longitudinal direction.

Further, by extending in the front-rear direction of the vehicle body, sufficient welding regions for spot welding can be ensured at the four corners of the joining flange 14b sufficiently separated from the bearing surface 14g.

Further, the length of the joining flange 14b in the front-rear direction of the vehicle body is set to be longer than at least the length of the lower wall 12c in the vehicle width direction. That is, the joining flange 14b has a length capable of abutting on the inner flange 12d. Therefore, rotation of the pipe nut 14 can be restricted without adding a new structure to the joining flange 14b. Then, by restricting the rotation of the pipe nut 14 in this manner, it is possible to improve workability when the pipe nut 14 is assembled to the front side frame 6.

Note that, although the setting of the shape and the like of the joining flange 14b has been described as an example of the whirl-stop of the pipe nut 14, a notch may be provided in a part of the distal end of the pipe nut main body 14a to restrict the rotation of the pipe nut 14. In this case, the shape of the upper insertion hole 12e is changed to a shape corresponding to the notch of the distal end of the pipe nut main body 14a.

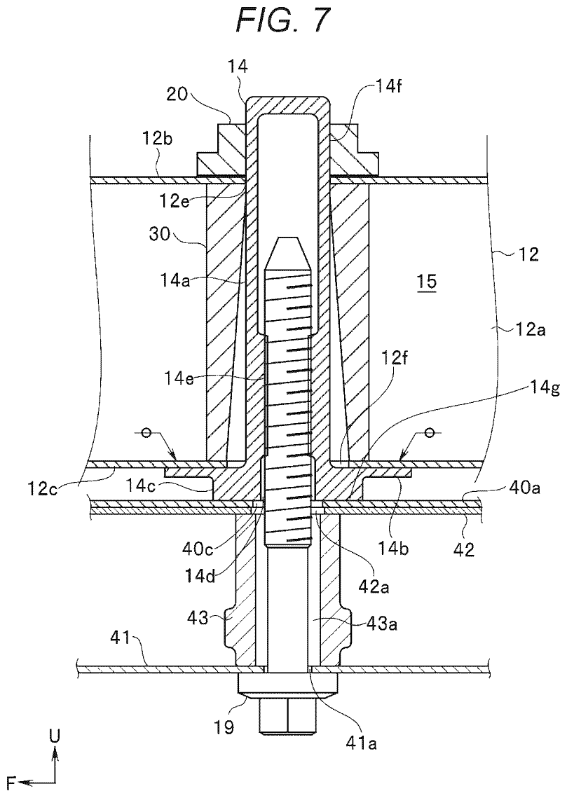

FIG. 7 illustrates a second embodiment of the disclosure. Components similar to those in the first embodiment are denoted by similar reference numerals, and description thereof is simplified or omitted.

The nut 20 of the first embodiment sandwiches the lower wall 12c of the front side frame 6 with the joining flange 14b.

On the other hand, a nut 20 of the present embodiment sandwiches the front side frame 6 with the joining flange 14b. Note that, in the present embodiment, the male screw portion 14f is formed, for example, from a distal end to a central portion in the longitudinal direction of the pipe nut main body 14a.

For example, the nut 20 is screwed onto the male screw portion 14f outside the front side frame 6 when the male screw portion 14f is inserted into the upper insertion hole 12e.

By such screwing with the male screw portion 14f, the nut 20 is disposed at a position in contact with the outer surface of the upper wall 12b. Thus, the nut 20 restricts the movement of the pipe nut main body 14a in the longitudinal direction.

Then, the nut 20 sandwiches the front side frame 6 with the joining flange 14b.

The front side frame 6 sandwiched in this manner has a spacer 30 therein.

The spacer 30 is disposed so as to cover the outer periphery of the pipe nut main body 14a. That is, the spacer 30 has a substantially cylindrical shape through which the pipe nut main body 14a can be inserted.

Both ends of the spacer 30 in the vehicle body vertical direction are fixed in a state of being in contact with an inner surface of the front side frame 6. Note that at least one of both ends of the spacer 30 is preferably joined to the inner surface of the front side frame 6.

With such a configuration, the fixing structure of the present embodiment can firmly fix the pipe nut 20 to the front side frame 6 just by screwing the nut 14 onto the distal end of the pipe nut main body 14a.

That is, the nut 20 in the present embodiment also functions as a joining means for fixing the distal end of the pipe nut main body 14a to the upper wall 12b. This makes it possible to omit the welding step by arc welding as in the first embodiment. Therefore, the fixing structure of the pipe nut 14 of the present embodiment can enhance the production efficiency as compared with the first embodiment.

In addition, the front side frame 6 includes the spacer 30 therein. Such a spacer 30 generates a drag against a pressing force concentrated on the outer surface of the front side frame 6 when the nut 20 is screwed onto the distal end of the pipe nut main body 14a. Thus, even if the nut 20 is tightened with a strong force, deformation of the plate material (deformation of the upper wall 12b and the lower wall 12c) of the front side frame 6 can be prevented. Accordingly, tightening strength of the nut 20 with respect to the front side frame 6 can be increased. Therefore, even in a structure in which the pipe nut 14 is fixed by the nut 20 from the outside of the front side frame 6, sufficient attachment rigidity of the pipe nut 14 with respect to the front side frame 6 can be ensured.

Further, in the case of the fixing structure of the present embodiment, it is also possible to improve the service performance by omitting the spot welding.

That is, by omitting the spot welding at the time of joining the joining flange 14b to the lower wall 12c, the pipe nut 14 can be easily replaced just by releasing the screwing of the nut 20. Thus, the pipe nut 14 can be set as a replacement part depending on the vehicle type to be applied. Therefore, in the case of the fixing structure of the present embodiment, service performance can be improved by omitting the spot welding.

Since the other configurations are similar to those of the first embodiment, the description thereof will be omitted.

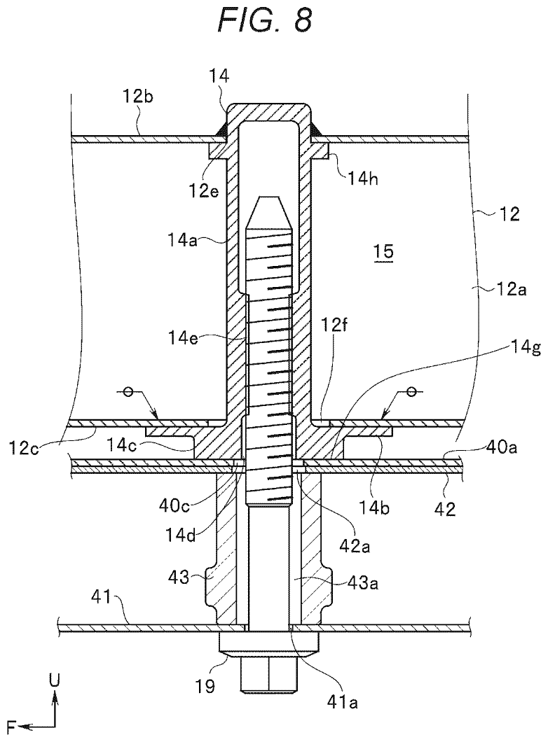

FIG. 8 illustrates a third embodiment of the disclosure. Components similar to those in the first and second embodiments are denoted by similar reference numerals, and description thereof is simplified or omitted.

In the present embodiment, as a second stopper, the positioning flange 14h is integrally formed at an intermediate position on the distal end side of the pipe nut main body 14a.

For example, as illustrated in FIG. 8, the positioning flange 14h is annularly projected on the outer periphery on the distal end side of the pipe nut main body 14a. That is, the outer diameter of the positioning flange 14h is set to be larger than the diameter of the upper insertion hole 12e.

With such a setting, when the distal end of the pipe nut main body 14a is inserted into the upper insertion hole 12e, the upper surface of the positioning flange 14h is positioned in a state of being in contact with the inner surface of the upper wall 12b.

Further, when the positioning flange 14h comes into contact with the upper wall 12b, the joining flange 14b is in contact with the outer surface of the lower wall 12c.

Then, the distal end of the positioned pipe nut main body 14a is joined to the upper wall 12b by arc welding. Furthermore, the joining flange 14b abutting on the outer surface of the lower wall 12c is joined by spot welding.

Note that, in the present embodiment, the diameter of the lower insertion hole 12f is set to be slightly larger than the outer diameter of the positioning flange 14h. Accordingly, when the distal end of the pipe nut main body 14a is inserted into the lower insertion hole 12f, the positioning flange 14h is inserted without interfering with the lower wall 12c.

With a simpler configuration than the first embodiment, such a pipe nut 14 can generate a drag against a load in the prying direction and the longitudinal direction input to the pipe nut main body 14a via the suspension cross member 9 during traveling. That is, the configuration can be simplified by employing the fixing structure using the pipe nut 14 of the present embodiment according to the vehicle type.

Since the other configurations are similar to those of the first embodiment, the description thereof will be omitted.

Note that the disclosure described in the above embodiments (first to third embodiments) is not limited to those embodiments, and various modifications can be made in the implementation stage without departing from the gist thereof.

For example, the fixing structure of the pipe nut 14 described in each of the above embodiments (first to third embodiments) can also be used for a fastening portion between a vehicle body and a seat, a fastening portion between a vehicle body and a battery case mounted on an electric vehicle, or the like.

Furthermore, the above-described embodiments include inventions at various stages, and various inventions can be extracted by appropriately combining disclosed constituent elements.

Further, for example, when the problem to be solved in the disclosure can be solved and the described effect can be obtained even if some constituent elements are deleted from all the constituent elements described in the above embodiments, the configuration from which the constituent elements are deleted can be extracted as an invention.

1. A fixing structure for a pipe nut, the fixing structure comprising:
a pipe nut main body inside of which a female screw portion is provided, the pipe nut main body penetrating a vehicle body frame having a hollow cross section;
a first stopper that is provided at a base end of the pipe nut main body and abuts on an outer surface of the vehicle body frame to restrict movement of the pipe nut main body in a longitudinal direction; and
a second stopper that is provided on the pipe nut main body and abuts on a surface of the vehicle body frame different from the outer surface of the vehicle body frame on which the first stopper abuts, the second stopper restricting movement of the pipe nut main body in the longitudinal direction.

2. The fixing structure for a pipe nut according to claim 1, wherein
the second stopper is a nut screwed onto an outer periphery of the pipe nut main body, and
the second stopper sandwiches a plate member of the vehicle body frame on which the first stopper abuts with the first stopper.

3. The fixing structure for a pipe nut according to claim 1, wherein
the second stopper is a nut screwed onto an outer periphery of the pipe nut main body, and
the second stopper sandwiches the vehicle body frame with the first stopper.

4. The fixing structure for a pipe nut according to claim 3, further comprising a spacer that is provided on an outer periphery of the pipe nut main body and has both ends in contact with an inner surface of the vehicle body frame inside the vehicle body frame.

5. The fixing structure for a pipe nut according to claim 1, wherein the first stopper is joined to an outer surface of the vehicle body frame by spot welding.

6. The fixing structure for a pipe nut according to claim 2, wherein the first stopper is joined to an outer surface of the vehicle body frame by spot welding.

7. The fixing structure for a pipe nut according to claim 3, wherein the first stopper is joined to an outer surface of the vehicle body frame by spot welding.

8. The fixing structure for a pipe nut according to claim 4, wherein the first stopper is joined to an outer surface of the vehicle body frame by spot welding.
